(19) United States
(12) Patent Application Publication
(10) Pub. No.: US 2026/0036811 A1
(43) Pub. Date: Feb. 5, 2026

(54) DIOPTER ADJUSTMENT SYSTEM AND HEAD-MOUNTED APPARATUS COMPRISING THE SAME

(71) Applicant: Varjo Technologies Oy, Helsinki (FI)

(72) Inventor: Jukka Manni, Helsinki (FI)

(73) Assignee: Varjo Technologies Oy, Helsinki (FI)

(21) Appl. No.: 18/792,793

(22) Filed: Aug. 2, 2024

(51) Int. Cl. G02B 27/01; G02B 15/14

(52) U.S. Cl. CPC G02B 27/0172; G02B 15/14; G02B 27/0149; G02B 27/0179; G02B 2027/014; G02B 2027/0154; G02B 2027/0187

(57) ABSTRACT

A diopter adjustment system for a head-mounted display apparatus, the diopter adjustment system including a stacked configuration and a distance adjusting means. The stacked configuration comprises: an objective lens having a first side and a second side; an eyepiece lens at a first distance from the first side of the objective lens; a display at a fixed distance from the second side of the objective lens. The distance adjusting means is configured to adjust the first distance axially along an optical axis to focus the display.

### TECHNICAL FIELD

The present disclosure relates to diopter adjustment systems for head-mounted display apparatuses. The present disclosure also relates to head mounted display apparatuses comprising the diopter adjustment systems.

### BACKGROUND

Nowadays, there is an increased demand for extended reality (XR) devices across various fields such as entertainment, real estate, training, medical imaging operations, simulators, navigation, and the like. Such XR devices typically involve head-mounted displays (HMDs) which are designed to offer immersive visual experiences. However, there is a significant design challenge within the HMDs while trying to accommodate eyeglasses of users. Such incorporation of eyeglasses requires additional space within the HMDs, which often results in bulky, complex, and heavy design. This inadvertently compromises an overall user experience using the HMD. Additionally, HMDs that are designed for shared use cases, present significant challenges due to varying specifications of the eyeglass of different users. Several approaches have been made to address these problems. However, existing approaches have several problems associated therewith.

Firstly, conventional HMDs allow users to wear their eyeglasses while using the HMDs. This is achieved by providing a space for the eyeglasses and incorporating adjustable clearance between the eye and the eyeglasses. This approach maintains a field of view (FOV) of the user who wears the eyeglasses. However, users that do not wear the eyeglasses experience will have a reduced FOV due to the space reserved for the eyeglasses. Hence, exchangeable cushions and moving mechanisms are arranged within the conventional HMDs to accommodate different needs of the users either wearing or not wearing the eyeglasses. However, such exchangeable cushions and moving mechanisms make the conventional HMDs large and bulky in design.

Secondly, the conventional HMDs allow use of clip-on prescription lens inserts that are provided by third parties, wherein the clip-on prescription lens inserts are made based on an eye condition of the user. The use of such clip-on prescription lens inserts is space-efficient, and provides a same optical experience to the user as the user experiences with their own eyeglasses that are not clip-on prescription lens inserts. However, such clip-on prescription lens inserts are custom-made and different for every user. This prevents shared use of the HMDs. Therefore, such customizations can be inconvenient and costly for users.

Therefore, in light of the foregoing discussion, there exists a need to overcome the aforementioned drawbacks.

### SUMMARY

The present disclosure seeks to provide diopter adjustment systems for head-mounted display apparatuses and head-mounted display apparatuses comprising the diopter adjustment systems to provide a simple, yet efficient manner to adjust diopter settings within the HMD apparatus, enhancing user comfort and visual experience. The aim of the present disclosure is achieved by a diopter adjustment system for a head-mounted display apparatus and a head-mounted display apparatus comprising the diopter adjustment system as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1A illustrates a simplified exploded schematic view of a diopter adjustment system, FIG. 1B illustrates a detailed exploded schematic view of a diopter adjustment system, and FIG. 1C illustrates an assembled schematic view of the diopter adjustment system of FIG. 1B, FIG. 1D illustrates an exploded schematic view of the diopter adjustment system further comprising a distance adjusting motor, and FIG. 1E, illustrates an assembled schematic view of the diopter adjustment system of FIG. 1D further comprising the distance adjusting motor, in accordance with various embodiments of the present disclosure;

FIG. 2 illustrates an optical chamber per eye of a head-mounted display apparatus, in accordance with an embodiment of the present disclosure;

FIG. 3 illustrates an optical lens, in accordance with an embodiment of the present disclosure; and

FIG. 4 illustrates a block diagram of an architecture of a head-mounted display apparatus, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides a diopter adjustment system for a head-mounted display apparatus, the system comprising:
a stacked configuration comprising:
   an objective lens having a first side and a second side;
   an eyepiece lens at a first distance from the first side of the objective lens;
   a display at a fixed distance from the second side of the objective lens; and
   a distance adjusting means configured to adjust the first distance axially along an optical axis to focus the display.

The present disclosure provides the aforementioned diopter adjustment system for the head-mounted display apparatus (HMD), which facilitates a simple, yet accurate, and reliable way to adjust the first distance between the eyepiece lens and an objective lens. Herein, the first distance is adjusted by the distance adjusting means axially along the optical axis to focus the display towards a user's eye in real-time or near-real time, which ensures a personalized visual correction for the user. By adjusting the first distance axially, the diopter adjustment system can accommodate different diopter settings for individual users. This is particularly beneficial for users with varying refractive errors, for example, such as myopia, hyperopia, and astigmatism, ensuring each user can obtain a clear and comfortable viewing experience. The diopter adjustment system is simple, robust, fast, reliable, support real-time adjustment of the first distance axially, and can be implemented with ease.

In a second aspect, an embodiment of the present disclosure provides a head-mounted display apparatus comprising the diopter adjustment system according to any of the preceding claims per eye, wherein the head-mounted display apparatus further comprises
a gaze-tracking camera per eye;
at least one processor connected to the gaze tracking cameras and the diopter adjustment systems;
and wherein the diopter adjustment systems further comprise
a distance adjusting motor operable to adjust the first distance.

The present disclosure provides the aforementioned head-mounted display apparatus comprising the diopter adjustment system per eye, which facilitates automatic adjustment of the first distance. Herein, the distance adjusting motor allows for automated real-time adjustments of the first distance based on inputs from gaze-tracking cameras. Moreover, the integration of the gaze-tracking cameras enables the diopter adjustment system to automatically detect and adjust to the user's specific visual needs, reducing the need for manual adjustments and ensures a seamless, user-friendly viewing experience. The distance adjusting motor provides precise and consistent control over the axial movement in the first distance. Furthermore, this automation enhances user convenience, allowing for quick and effortless focus adjustments. Additionally, this dynamic adaptability ensures that the user's vision is always optimized, even as they move or change their gaze within a virtual or real-world environment. Furthermore, this user-friendly operation enhances the overall experience and makes the HMD apparatus more efficient and practical for shared use environments, where the HMD apparatus is shared among multiple users.

Throughout the present disclosure, the term “diopter adjustment system” refers to a mechanism integrated within the head-mounted display (HMD) apparatus, that is designed to adjust a focal distance axially of at least one optical element that is at least partially round. Herein, the at least one optical element interacts and manipulates light to focus. Optionally, the at least one optical element is implemented as at least one of: a lens, a mirror, a prism.

The term “diopter adjustment” refers to a process of modifying an optical power of the objective lens to achieve proper focus for a user's vision. Herein, a diopter is a unit of measurement used to describe a refractive power of the objective lens. In this regard, the diopter adjustment system enables the user to achieve clear and sharp images without a need for a corrective lens, by allowing adjustment of the optical power of the objective lens in the HMD apparatus.

It will be appreciated that the diopter adjustment system provides a manual control and/or an automatic control over a focal distance of the objective lens ensuring that the user with an eye condition, for example, such as myopia, hyperopia, and astigmatism, can experience visual clarity without a need for a corrective lens (namely, a prescription lens). Moreover, the diopter adjustment system enhances usability and convenience of the head-mounted display apparatus, particularly in a shared use case, as the focal distance of the objective lens is controlled.

Throughout the present disclosure, the term “head-mounted display apparatus” refers to a specialized equipment that is configured to present an extended-reality (XR) environment to the user, when said HMD apparatus, in operation, is worn by the user on his/her head. The HMD apparatus is implemented, for example, such as an XR headset, a pair of XR glasses, and the like, that is operable to display an object and/or a visual scene of the XR environment to the user. The term “extended-reality” encompasses virtual reality (VR), augmented reality (AR), mixed reality (MR), and the like. In this regard, the HMD apparatus comprises the diopter adjustment system for each eye of the user. This allows for independent adjustment of the focal distance for each objective lens per eye of the user, ensuring that both eyes can achieve focus according to the user's vision requirements.

The diopter adjustment system comprises the stacked configuration, in which components of the diopter adjustment system are arranged on top of each other. Herein, the objective lens, the eyepiece lens, the display, and the distance adjusting means are arranged sequentially in a vertical manner. In this regard, the objective lens is arranged between the eyepiece lens and the display, and the display is arranged between the objective lens and the distance adjusting means, wherein the components are arranged along an optical axis passing centrally through the components of the diopter adjustment system. Hence, when a point of reference is any eye of the user, the diopter adjustment system is arranged in an order as follows: the eyepiece lens, the objective lens, the display, and the distance adjusting means.

Throughout the present disclosure the term “objective lens” refers to an optical element that receives light from an object and create a focused image. Herein, the term “object” refers to an item or a scene that is being viewed through the HMD apparatus when it is worn by the user. In the case of the HMD apparatus, the observed object may be a virtual content, an augmented content, or similar. It will be appreciated that the first side of the objective lens is in proximity with the eyepiece lens in the stacked configuration. The first side of the objective lens is responsible for focusing the light coming from the display to the eyepiece lens. Moreover, the second side of the objective lens is opposite to the first side, wherein the second side of the objective lens is in proximity with the display in the stacked configuration. The second side of the objective lens is responsible for receiving the light from the display, when the HMD apparatus is in use. In other words, the light emanating from the display passes through the second side of the objective lens, gets focused, and then exits through the first side of the objective lens towards the eyepiece lens and finally reaches the user's eye.

Throughout the present disclosure the term “eyepiece lens” refers to an optical element that is accommodated within the HMD apparatus and is arranged at a first distance from the first side of the objective lens. The eyepiece lens is responsible for directing a projection of the visual scene towards the user's eye, when the HMD apparatus is worn by the user. Herein, the first distance is essential for achieving the focal distance and magnification of the visual scene that the user sees. In this regard, a primary function of the eyepiece lens is to further focus the light coming from the display that has already been focused by the objective lens. This further focusing of the light ensures that the visual scene formed by the objective lens is properly magnified and aligned for a comfortable visual experience by the user.

Optionally, the eye piece lens is implemented as at least one of: a convex lens, a plano-convex lens, a Liquid Crystal (LC) lens, a liquid lens, a Fresnel lens, an aspherical lens, an achromatic lens, a polymeric lens, a freeform lens, a polariser, a mirror, a semi-transparent mirror, a polarising mirror, a diffractive optical element.

Throughout the present disclosure the term “display” refers to a component that generates the visual scene to be viewed by the user. Examples of the display may include, but are not limited to, an Organic Light Emitting Diode (OLED), a Liquid Crystal Display LCD ( ), a MicroLED, and a Liquid Crystal on Silicon (LCOS). In this regard, the display is positioned at the fixed distance from the second side of the objective lens. Optionally, the fixed distance of the display is predetermined and maintained throughout the use of the HMD apparatus.

It will be appreciated that the fixed distance of the display ensures that the visual scene displayed is in focus and properly aligned with the user's field of view and allows for a consistent viewing experience.

Throughout the present disclosure the term “distance adjusting means” refers to a mechanism that is designed to change the first distance between the eyepiece lens and the first side of the objective lens as per requirement of the user. The primary purpose of the distance adjusting means is to ensure that the visual scene or the image displayed by the HMD apparatus is to configure the distance of the objective lens, which in turn properly allows to focus for the user's vision. Examples of the distance adjusting means may include, but are not limited to, a stepper motor, an electrical motor, a linear servo motor, a rack and pinion mechanism, and a piezoelectric actuator.

The term “optical axis” pertains to an imaginary line along which the light from the display passes through the objective lens and the eyepiece lens, before reaching the user's eye. In this regard, the first distance between the first side of the objective lens and the eyepiece lens is adjusted axially along the optical axis by the distance adjusting means. In other words, the adjustment is made along the direction in which the light travels through the objective lens and the eyepiece lens, and the axial adjustment involves using the distance adjusting means to move the objective lens closer or further apart along this optical axis to fine-tune the focus of the visual scene.

It will be appreciated that while adjusting the first distance, the eyepiece lens, the objective lens, and the display do not rotate with respect to each other. In other words, the adjustment of the first distance (between the eyepiece lens and the objective lens) is achieved without any rotational movement, which means that the objective lens move strictly along the optical axis in a linear manner.

By adjusting the first distance, the distance adjusting means ensures that the light coming from the display is properly converged by the objective lens and then correctly focused by the eyepiece lens. Furthermore, this adjustment ensures that the final image seen by the user is sharp, clear, and accommodating different users' vision needs.

In an embodiment, the eyepiece lens, the objective lens, and the distance adjusting means have a shape of a circular segment. The term “circular segment” refers to a region of a circle that is cut off from the rest by a chord, which is a straight line connecting two points on the circle's circumference. The circular segment is mainly characterized by two parts: a major segment and a minor segment. In this regard, the eyepiece lens and the objective lens have the shape of the circular segment which is in the minor segment. The technical benefit of the shape of the circular segment of the eyepiece lens and the objective lens is that it facilitates the positioning of the eyepiece lens, and the objective lens within the constrained space of the head-mounted display apparatus, and fits ergonomically around facial features, particularly around a nose area of the user. In this regard, the eyepiece lens and the objective lens are cut from nose side to allow them to be as close to the eye as possible. Moreover, the circular segment of the eyepiece lens and the objective lens provide a large field of view while maintaining proximity to the eye of the user.

It will be appreciated that the distance adjusting means also has the shape of the circular segment. The circular segment of the distance adjusting means allows for precise axial movement and facilitates the adjustment of the focal distance. Moreover, the circular segment shape ensures that the distance adjusting means fits seamlessly within the HMD display apparatus, avoiding interference with other components and maintaining the compactness of the diopter adjustment system.

Optionally, the stacked configuration further comprises:
a body configured to accommodate:
   at least one opening;
   a subassembly comprising:
      the objective lens,
      the display,
      at least one inclined opening,
the distance adjusting means movable relative to the body to define the distance comprising:
   at least one slider cylinder, which is configured to be movable via the at least one opening,
   at least one transmit pin configured to be movable via the at least one inclined opening by the at least one slider cylinder.
and wherein the movement of the at least one slider cylinder results in a change of the first distance.

In this regard, in the stacked configuration, the body pertains to a main housing that supports and contains other components such as the at least one opening, the subassembly, and the distance adjusting means.

Optionally, the body is comprised of two parts. The two parts of the body are: a top part, and a bottom part, that are hollow. In this regard, the eyepiece lens is arranged within the top part of the body, and the subassembly and the distance adjusting means is arranged within the bottom part of the body. Hence, when the top and the bottom part of the body are assembled, the eyepiece lens, the objective lens, the display, the distance adjusting means are encompassed within the body.

The term “subassembly” refers to a group of components that are pre-assembled into a smaller unit within the diopter adjustment system. In this regard, in the subassembly, the display is at least one of: the fixed distance, a fixed position, from the second side of the objective lens, wherein the objective lens is positioned in an optical path of the light coming from the display to focus the image. In particular, when adjusting distance of the objective lens, the display does not move and is fixed. Furthermore, the at least one inclined opening is the part of the subassembly, that is designed to facilitate the movement of the distance adjusting means. The at least one inclined opening allows for the axial movement, enabling adjustments of the first distance between the objective lens and the eyepiece lens.

Moreover, in the distance adjusting means, the at least one slider cylinder is a movable component that operates within the body of the diopter adjustment system. The at least one slider cylinder is configured to move through the at least one opening in the body, allowing a shift in position along a defined path, wherein the at least one opening acts as a channel or track for the at least one slider cylinder. In this regard, the at least one opening provides a controlled path for a movement of the at least one slider cylinder.

Furthermore, the at least one transmit pin is another movable component in the distance adjusting means that interacts with the at least one slider cylinder. The at least one transmit pin is positioned at an end of the at least one slider cylinder, wherein the at least one transmit pin faces objective lens and the display. The at least one transmit pin moves via the at least one inclined opening, wherein the at least one inclined opening guides the at least one transmit pin and helps in converting the movement of the at least one slider cylinder into the axial adjustment that is required.

This movement of the at least one slider cylinder via the at least one opening, guided by the at least one transmit pin through the at least one inclined opening, results in a change of the first distance between the eyepiece lens and the objective lens. The technical benefit of this arrangement in the stacked configuration is that it adjusts the distance of the objective lens without rotating the display, the eyepiece lens, and/or the objective lens. This allows less wear and tear of the components within the diopter adjustment system, as less friction is introduced due to no rotational movement of the components within the diopter adjustment system. Hence, such configuration facilitates a compact and streamlined design of the diopter adjustment system.

In an embodiment, the body, the subassembly, and the distance adjusting means have a shape of a circular segment. In this regard, the circular segment of the body allows the eyepiece lens to be accommodated properly wherein the eyepiece lens have the shape of the circular segment. Moreover, the circular segment of the subassembly also provides a proper fit to the objective lens and the display, wherein the objective lens and the display also have the shape of the circular segment. Furthermore, the circular segment of the distance adjusting means allows smooth movement within curved confines of the body and subassembly, ensuring precise adjustments without requiring additional space or complexity. The technical benefit of the shape of the circular segment is to provide flexibility of using the HMD apparatus. The circular segment is chosen for providing the large field of view to the user who requires the corrective lens and for the user who does not require the corrective lens. Moreover, the shape of the circular segment of the body, the subassembly, and the distance adjusting means perfectly aligns with the shape of the eyepiece lens which facilitates the user a more comfortable and immersive experience.

Optionally, the distance adjusting means is electro-mechanically movable by at least one of: a stepper motor, an electrical motor. In this regard, when the distance adjusting means is electro-mechanically moved by using the stepper motor, the first distance is adjusted in a discrete manner. The stepper motor is configured in such a manner that a number of steps is controlled so that precise and accurate adjustment is achieved. The technical benefit of using the stepper motor is that it ensures focusing the visual scene for the user accurately, based on the eye conditions of the user, by precisely adjusting the first distance. Since each step of the stepper motor corresponds to a known, precise movement, the diopter adjustment system can reliably replicate same level of adjustment every time for a different user. This consistency is crucial for maintaining optimal focus, especially if the HMD is to be frequently adjusted, wherein such adjustment is performed either manually by the user or automatically.

Optionally, when the distance adjusting means is electro-mechanically moved by using the electrical motor, the first distance is adjusted precisely in a fast manner. In this regard, the electrical motor provides continuous rotation, wherein a speed of the electrical motor is controlled electronically. The technical benefit of using the electrical motor is that it ensures high efficiency without making the HMD apparatus bulky.

Optionally, the distance adjusting means further comprises a segment gear wherein the segment gear is connected to a worm gear. The term “segment gear” refers to a gear with a non-full circular section containing teeth around its periphery. Moreover, the term “worm gear” refers to a type of gear that is used to convert a rotary motion from the at least one of: the stepper motor, the electrical motor, into a linear motion along the optical axis. The worm gear has a cylindrical body, and it has a continuous, helical thread wrapped around its cylindrical body, with a wide head and teeth on one end. It will be appreciated that the at least one of: the stepper motor, at least one of: the stepper motor, the electrical motor, is connected to the worm gear, wherein the worm gear is connected to the segment gear via one or more openings which is at the lower portion of the bottom part of the body.

In this regard, when the at least one of: the stepper motor, the electrical motor provides the rotary motion, it is transferred to the worm gear. As the worm gear rotates, its thread meshes with the teeth of the segment gear. This meshing creates a pushing force between the worm gear and the segment gear. The segment gear translates the pushing force from the worm gear into the linear motion that is further used to move the distance adjusting means.

The technical benefit of using the worm gear is that it has a high gear ratio, which enables precise movement in axial direction. Additionally, the worm gear's natural self-locking function ensures that the at least one of: the stepper motor, the electrical motor, cannot be rotated by merely pushing the eyepiece lens and the objective lens. Furthermore, combination of the worm gear and the segment gear offers a significant mechanical advantage in terms of adjusting the first distance, wherein a small rotation of the at least one of: the stepper motor, the electrical motor can result in a linear movement of the segment gear, thereby enabling precise adjustments of the first distance.

In an embodiment, the segment gear extends through the at least one opening. It will be appreciated that the segment gear is partially positioned at a front side of the distance adjusting means and it extends through the at least one opening of the body. In other words, from the bottom part of the body, the teeth of the segment gear are extended outwards. Upon extending the teeth in such a manner, the segment gear interacts with the worm gear, to facilitate movement of the distance adjusting means. The technical benefit of this design is that it allows for the precise adjustment of the position of the objective lens by enabling the segment gear to move axially along the optical axis, thereby adjusting the first distance between the objective lens and the eyepiece lens without requiring at least one of: the objective lens, the eyepiece lens, to rotate. This ensures that the at least one of: the objective lens, the eyepiece lens maintain their correct orientation relative to each other, which is essential for maintaining proper focus and optical alignment in the HMD apparatus.

Optionally, the distance adjusting means comprises a magnet to create a linear force, and by varying a magnetic field, the distance adjusting means moves axially. A technical benefit of using the magnet is that it provides precise control and can be designed for high accuracy. Moreover, there is no mechanical contact which reduces wear and tear.

Optionally, the diopter adjustment system further comprises a sensor operable to detect the first distance between the eyepiece lens and the objective lens. In this regard, the sensor is configured to detect a position of the distance adjusting means, which moves in an axial manner. Optionally, the sensor is arranged near the distance adjusting means to collect sensor information, and the sensor information is processed to determine movement provided by the distance adjusting means. The sensor detects the exact position and sends this information to at least one processor of the HMD apparatus. The at least one processor uses this information to make precise adjustments, ensuring that the objective lens and the eyepiece lens are correctly aligned for focusing the image in an accurate manner. Examples of the sensor may include, but are not limited to, an optical encoder sensor, an ultrasonic sensor, a capacitive sensor, an infrared sensor, and a Time-of-Flight sensor. The technical benefit of using the sensor in such a manner is that it is ensured that the sensor information collected from the sensor can be used by the at least one processor to automatically adjust the first distance without manual intervention. This makes the diopter adjustment system more user-friendly and reduces the effort required from the user to achieve a correct focus.

The present disclosure also relates to the second aspect as described above. Various embodiments and variants disclosed above, with respect to the aforementioned first aspect, apply mutatis mutandis to the second aspect.

Throughout the present disclosure the term “gaze-tracking camera” refers to a specialized equipment for detecting and/or following gaze of the user's eyes. The gaze-tracking cameras monitor a position, a size and/or a shape of a pupil of the user's eye, and the like. Such gaze-tracking cameras are well-known in the art.

Throughout the present disclosure the term “distance adjusting motor” refers to a mechanism within the diopter adjustment system that is designed to adjust the first distance between the eyepiece lens and the objective lens to achieve focus based on the user's visual requirements. The distance adjusting motor facilitates precise axial movement without any rotational movement of the objective lens. The function of the distance adjusting motor is described earlier in detail.

It will be appreciated that the HMD apparatus includes the gaze-tracking cameras for each eye that enables real-time automatic adjustment based on the user's eye characteristics. Moreover, by tracking the user's gaze, the gaze-tracking cameras allows for precise user identification. This ensures that each user receives a customized experience based on their preferences. Furthermore, the gaze-tracking cameras measure a distance between the pupils of the user's eye which is unique to each individual. This measurement facilitates in both user identification and optimizing visual comfort.

In one instance, when using the HMD apparatus for a first time, at least one personal setting may be automatically configured by the HMD apparatus. In another instance, an input could be provided by the user using an input device associated with the user. Such input is provided manually by the user. Additionally, the at least one personal setting is then stored in a database (for example, such as a cloud-based database, a cloud-computing database, a library, a file, and the like). It will be appreciated that the at least one personal setting is unique to each user and may vary according to the user's need and comfort level.

Furthermore, when the user wears the HMD apparatus for subsequent uses, the at least one processor retrieves the at least one personal setting from the database. The distance adjusting motor then adjusts the first distance between the objective lens and the eyepiece lens accordingly, thus ensuring a personalized user experience each time the HMD apparatus is used.

Optionally, the gaze-tracking cameras are selected from at least one of: an infrared camera, a RGB camera, near-infrared cameras. When the gaze-tracking camera is implemented as the infrared camera, images of the user's eye are captured in standard conditions in which images of both eyes of the user are taken. The infrared camera captures detailed images of the eye. In this regard, characteristics of the eye are then compared with the at least one personal setting stored in the database to identify the user accurately. A technical benefit of using the infrared camera is that it enables using images of the eye for the user identification, even under low-light conditions.

When the gaze-tracking camera is implemented as a Red-Green-Blue (RGB) camera, high-resolution color images of the user's eyes are captured, wherein such high-resolution color images comprise at least the pupil, and surrounding features of the pupil. These high-resolution color images are then used to identify the user by matching at least one of: an eye color, a shape, an overall facial structure, of the user. When the gaze-tracking camera is implemented as the near-infrared camera, highly detailed images of the eye are captured, which are then matched with the at least one personal setting to identify the user accurately. A technical benefit of providing such selection of the gaze-tracking cameras is that it provides versatility and user comfort in various lighting conditions and applications.

Once the user is identified, the distance adjusting motor automatically adjusts the first distance as well as other personalized settings according to the at least one personal setting of the user.

Optionally, the at least one processor is configured to control the distance adjusting motors by processing a data collected by the gaze-tracking cameras.

The term “data” refers to information captured and processed by the gaze-tracking cameras. The data may include information about at least one of: an exact location, movement of the user's eyes, a specific point in the field of view where the user is looking, the distance between the centers of the user's pupils, patterns and characteristics of the user's iris, the shape and orientation of the iris. Herein, the movement of the user's eyes is at least one of: a change in direction of their gaze, a change in eye position, a change in a size of the user's pupils, and the like.

In this regard, the gaze-tracking cameras, continuously capture images of the user's eyes. The captured images are then transmitted to the at least one processor. Furthermore, using advanced image processing algorithms, the at least one processor analyzes the captured images to determine the precise position and orientation of the user's eyes. This analysis includes identifying the user's gaze point, irises, measuring the interpupillary distance (IPD), detecting any specific eye characteristics necessary for user identification and the like. The at least one processor identifies the user by comparing this data to the at least one personal setting stored in the database. For example, if five users out of a hundred have the same IPD, the comparison is made between those five users instead of all one hundred.

Once the user is identified, the at least one processor retrieves the stored personal settings, including the optimal diopter adjustment values, from the database. Based on the analyzed data and at least one personal setting that are retrieved from the database, the at least one processor generates control signals. These control signals are precisely calibrated to adjust the first distance between the eyepiece lens and the objective lens, ensuring that the display is focused correctly for the identified user. The control signals are sent to the distance adjusting motor. The distance adjusting motor receives the control signals and moves the distance adjusting means axially along the optical axis. This movement adjusts the first distance between the eyepiece lens and the objective lens. The at least one processor continuously monitors the data from the gaze-tracking cameras to make real-time adjustments as per requirement of the user.

The technical benefit of controlling the distance adjusting motors by processing the data in such a manner is that it is ensured that any change in the user's eye position or focus requirements are immediately addressed, thus maintaining optimal visual clarity and comfort. Moreover, there is a significant reduction in time and effort in shared use cases, for example, such as when pilot training.

### DETAILED DESCRIPTION OF THE DRAWINGS

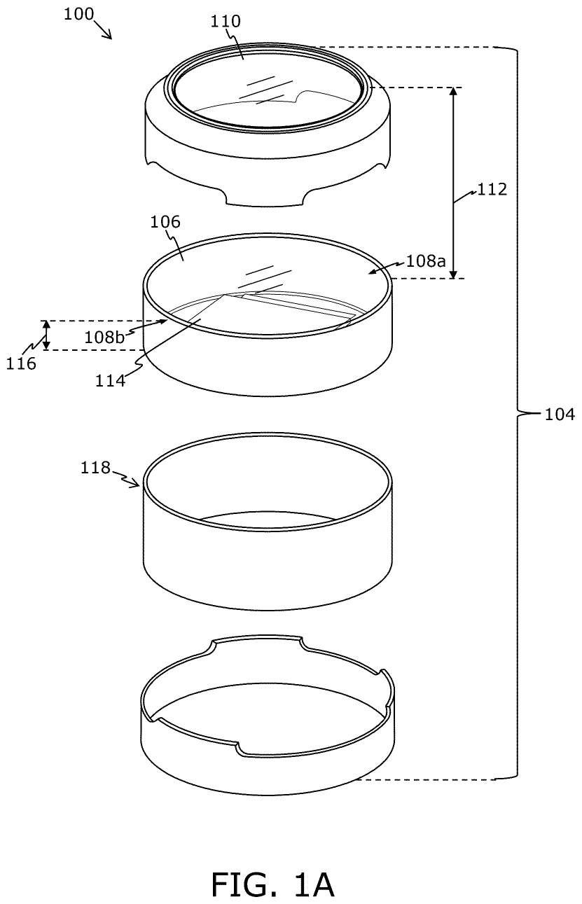

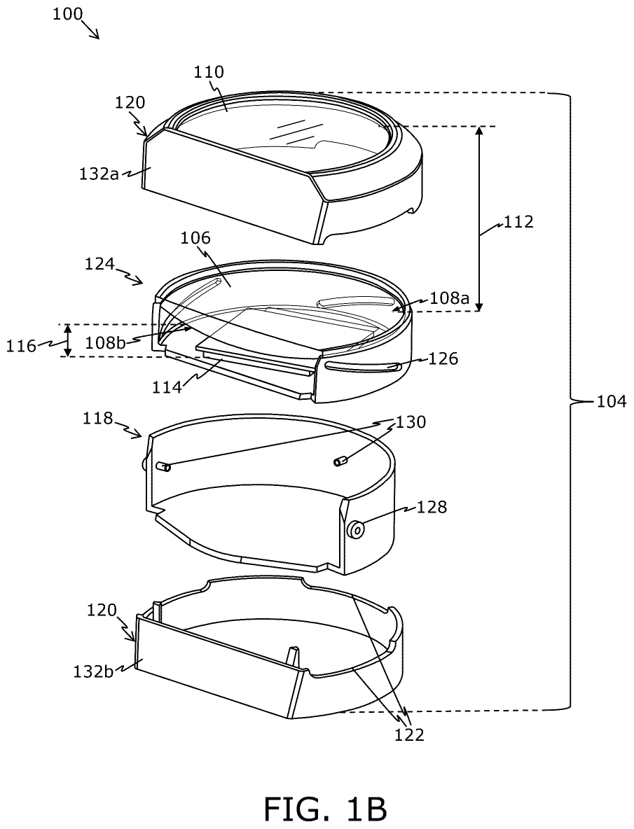

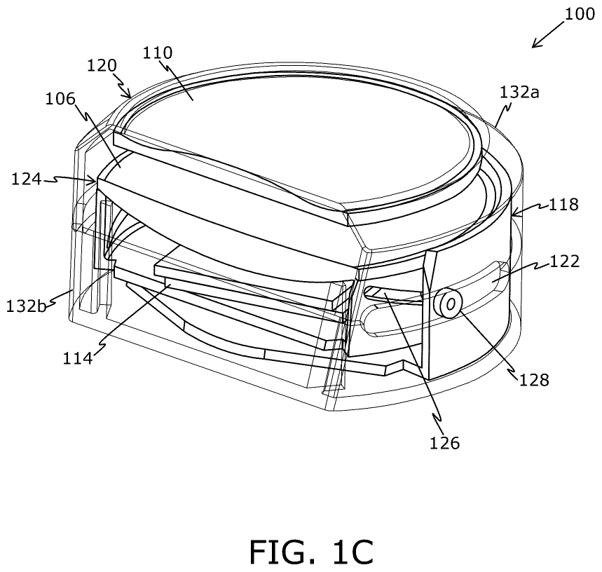

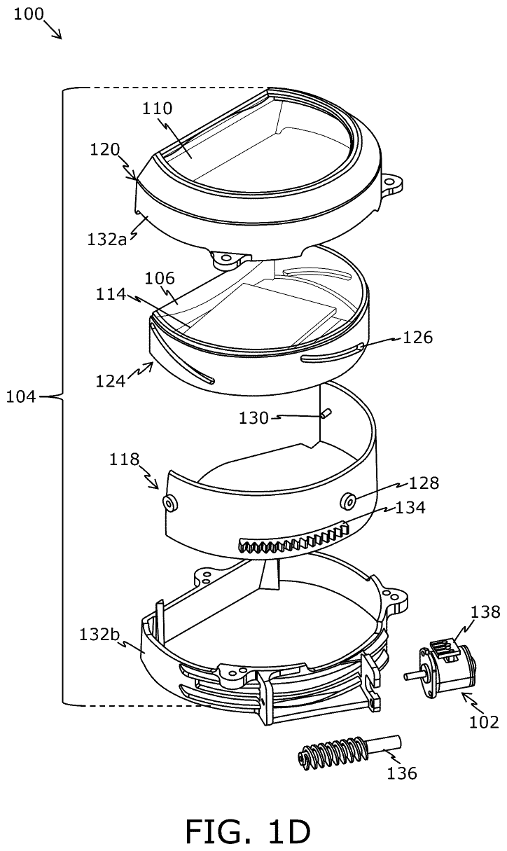

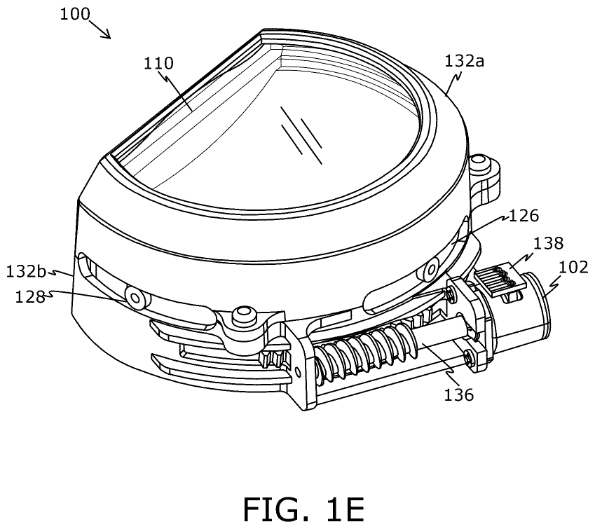

Referring to FIG. 1A, illustrated is a simplified exploded schematic view of a diopter adjustment system 100, referring to FIG. 1B, illustrated is a detailed exploded schematic view of a diopter adjustment system 100, referring to FIG. 1C, illustrated is an assembled schematic view of the diopter adjustment system 100 of FIG. 1B, referring to FIG. 1D, illustrated is an exploded schematic view of the diopter adjustment system 100 further comprising a distance adjusting motor 102, and referring to FIG. 1E, illustrated is an assembled schematic view of the diopter adjustment system 100 of FIG. 1D further comprising the distance adjusting motor 102, in accordance with different embodiments of the present disclosure. With reference to FIG. 1A, the diopter adjustment system 100 comprises a stacked configuration 104. The stacked configuration 104 comprises an objective lens 106 having a first side 108a and a second side 108b, an eyepiece lens 110 at a first distance 112 from the first side 108a of the objective lens 106, a display 114 at a fixed distance 116 from the second side 108b of the objective lens 106, and a distance adjusting means 118. Herein, constituents of the diopter adjustment system 100 are fully round.

With reference to FIG. 1B, constituents of the diopter adjustment system 100 are at least partially round. Optionally, the stacked configuration 104 further comprises a body 120 configured to accommodate, at least one opening (depicted as an opening 122), a subassembly 124 and the distance adjusting means 118. Herein, the subassembly 124 comprises the objective lens 106, the display 114, and at least one inclined opening (depicted as an inclined opening 126). The distance adjusting means 118 comprises at least one slider cylinder (depicted as a slider cylinder 128), and at least one transmit pin (depicted as transmit pins 130). Optionally the body 120 comprises two parts (depicted as a top part 132a and a bottom part 132b.

With reference to FIG. 1C, illustrated is an assembled schematic view of the diopter adjustment system 100 of FIG. 1B. As shown, the top part 132a and the bottom part 132b of the body 120 is assembled together to form the opening 122. In this regard, the entire stacked configuration 104 is assembled between the top part 132a and the bottom part 132b of the body 120. Moreover, the slider cylinder 128 is configured to be movable via the opening 122 wherein the at least one transmit pin 130 (not shown in FIG. 1B for the sake of clarity) is configured to be movable via the at least one inclined opening 126 by the at least one slider cylinder 128.

With reference to FIG. 1D, the diopter adjustment system 100 further comprises the distance adjusting motor 102. Additionally, optionally, the distance adjusting means 118 further comprises a segment gear (depicted as a segment gear 134), wherein the segment gear 134 is connected to a worm gear 136. Optionally, the diopter adjustment system 100 further comprises a sensor 138. With reference to FIG. 1E, optionally, the sensor 138 is arranged on top of the distance adjusting motor 102 in close proximity to the distance adjusting means 118 comprised in the diopter adjustment system 100 of FIG. 1D.

FIGS. 1A-1E are merely examples, which should not unduly limit the scope of the claims herein. The person skilled in the art will recognize many variations, alternatives, and modifications of embodiments of the present disclosure.

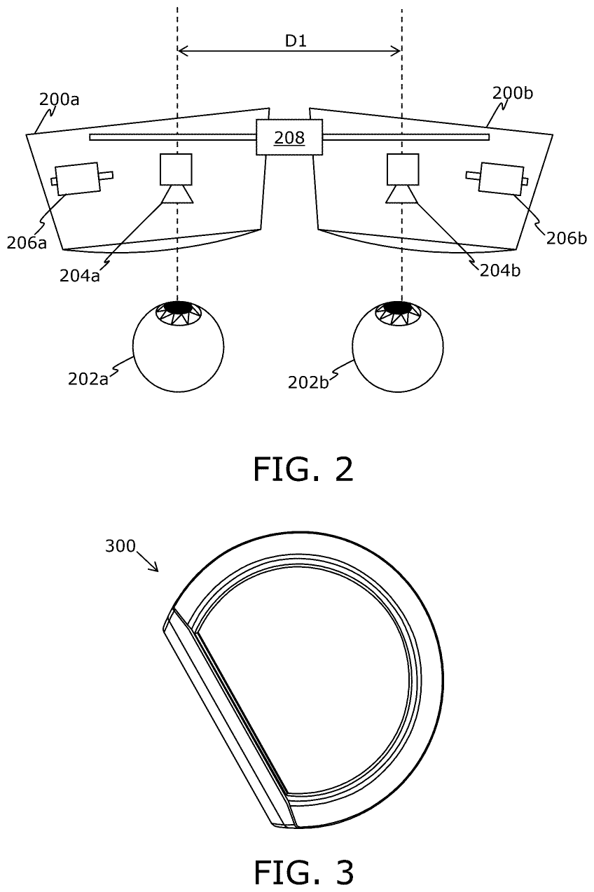

Referring to FIG. 2, illustrated is an internal view of a head-mounted display apparatus, in accordance with an embodiment of the present disclosure. The head-mounted display apparatus comprises a diopter adjustment system per eye. Optionally, in the internal view, the head-mounted display apparatus further comprises an optical chamber per eye (depicted as optical chambers 200a and 200b for a first eye 202a and a second eye 202b of the user, respectively). The head-mounted display apparatus further comprises a gaze-tracking camera per eye (depicted as gaze-tracking cameras 204a and 204b for the first eye 202a and the second eye 202b of the user, respectively), and at least one processor (not shown for sake of simplicity). The diopter adjustment system further comprises a distance adjusting motor per eye (depicted as distance adjusting motor 206a and 206b for the first eye 202a and the second eye 202b of the user, respectively). Optionally, an interpupillary distance motor 208 is arranged in the optical chambers 200a-b. The at least one processor is communicably coupled with the diopter adjustment system, the gaze-tracking cameras 204a-b, the distance adjusting motors 206a-b, and optionally, the interpupillary distance motor 208.

It will be appreciated that the gaze-tracking cameras 204a-b capture an image of the user's eyes, and the interpupillary distance motors 208a-b measure a distance D1 between pupils of the first eye 202a and the second eye 202b of the user.

FIG. 2 is merely an example, which should not unduly limit the scope of the claims herein. The person skilled in the art will recognize many variations, alternatives, and modifications of embodiments of the present disclosure.

Referring to FIG. 3 illustrated is a shape of the eyepiece lens 110 of diopter adjustment system 100 of FIG. 1A, in accordance with an embodiment of the present disclosure. Herein, the eyepiece lens 110, the objective lens 106, and the distance adjusting means 118 have a shape of a circular segment. Optionally, the body 120, the subassembly, and the distance adjusting means have a shape of a circular segment.

FIG. 3 is merely an example, which should not unduly limit the scope of the claims herein. The person skilled in the art will recognize many variations, alternatives, and modifications of embodiments of the present disclosure.

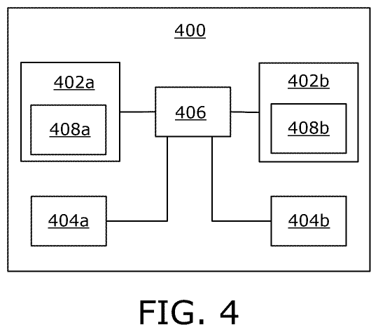

Referring to FIG. 4, illustrated is a block diagram of an architecture of a head-mounted display apparatus 400, in accordance with an embodiment of the present disclosure. The head-mounted display apparatus 400 comprises a diopter adjustment system per eye (for example, depicted as diopter adjustment system 402a for a first eye and diopter adjustment system 402b for a second eye). The head-mounted display apparatus 400 further comprises a gaze-tracking camera per eye (depicted as a gaze-tracking cameras 404a and 404b for the first eye and the second eye, respectively), at least one processor (for example, depicted as a processor 406). The processor 406 is communicably coupled to the gaze tracking cameras 404a-b and the diopter adjustment systems 402a-b. The diopter adjustment systems 402a-b further comprises a distance adjusting motor per eye (for example, depicted as distance adjusting motor 408a and 408b for the first eye and the second eye, respectively) operable to adjust a first distance.

It may be understood by a person skilled in the art that FIG. 4 includes a simplified architecture of the head-mounted display apparatus 400 for sake of clarity, which should not unduly limit the scope of the claims herein. It is to be understood that the specific implementation of the head-mounted display apparatus 400 is provided as an example, and is not to be construed as limiting it to specific numbers or types of, diopter adjustment systems, distance adjusting motors, cameras, and processors. A person skilled in the art will recognize many variations, alternatives, and modifications of embodiments of the present disclosure.

1. A diopter adjustment system for a head-mounted display apparatus, the diopter adjustment system comprising
a stacked configuration comprising:
an objective lens having a first side and a second side;
an eyepiece lens at a first distance from the first side of the objective lens;
a display at a fixed distance from the second side of the objective lens;
a distance adjusting means configured to adjust the first distance axially along an optical axis to focus the display.

2. The diopter adjustment system according to claim 1, wherein the stacked configuration further comprises:
a body configured to accommodate:
at least one opening;
a subassembly comprising:
the objective lens,
the display,
at least one inclined opening,
the distance adjusting means movable relative to the body to define the first distance, comprising
at least one slider cylinder, which is configured to be movable via the at least one opening,
at least one transmit pin configured to be movable via the at least one inclined opening by the at least one slider cylinder.
and wherein the movement of the at least one slider cylinder results in a change of the first distance.

3. The diopter adjustment system according to claim 1, wherein the eyepiece lens, the objective lens, and the distance adjusting means have a shape of a circular segment.

4. The diopter adjustment system according to claim 2, wherein the body, the subassembly, and the distance adjusting means have a shape of a circular segment.

5. The diopter adjustment system according to claim 1, wherein the distance adjusting means further comprises a segment gear wherein the segment gear is connected to a worm gear.

6. The diopter adjustment system according to claim 5, wherein the segment gear extends through the at least one opening.

7. The diopter adjustment system according to claim 1, wherein the distance adjusting means is electro-mechanically movable by at least one of: a stepper motor, an electrical motor.

8. The diopter adjustment system according to claim 1, wherein the diopter adjustment system further comprises a sensor operable to detect the first distance between the eyepiece lens and the objective lens.

9. The diopter adjustment system according to claim 2, wherein the body is comprised of two parts.

10. A head-mounted display apparatus comprising the diopter adjustment system according to claim 1 per eye, wherein the head-mounted display apparatus further comprises
a gaze-tracking camera per eye;
at least one processor connected to the gaze tracking cameras and the diopter adjustment systems;
and wherein the diopter adjustment systems further comprise:
a distance adjusting motor operable to adjust the first distance.

11. The head-mounted display apparatus according to claim 10, wherein the gaze-tracking cameras are selected from at least one of: an infrared camera, a RGB camera, near-infrared cameras.

12. The head-mounted display apparatus according to claim 10, wherein the at least one processor is configured to control the distance adjusting motors by processing a data collected by the gaze-tracking cameras.
